(19) United States
(12) Patent Application Publication
(10) Pub. No.: US 2026/0010296 A1
(43) Pub. Date: Jan. 8, 2026

(54) DATA ORGANIZATION METHOD AND APPARATUS FOR REDUNDANT ARRAY OF INDEPENDENT DISKS, AND SERVER AND MEDIUM

(71) Applicant: Suzhou MetaBrain Intelligent Technology Co., Ltd., Suzhou, Jiangsu (CN)

(72) Inventors: Hongyu ZHU, Suzhou, Jiangsu (CN); Tao SU, Suzhou, Jiangsu (CN)

(21) Appl. No.: 19/130,210

(22) PCT Filed: Nov. 27, 2023
(86) PCT No.: PCT/CN2023/134448

§ 371 Date: May 15, 2025

(30) Foreign Application Priority Data
Nov. 29, 2022 (CN) 202211507733.5

(51) Int. Cl. G06F 3/06

(52) U.S. Cl. CPC G06F 3/0619; G06F 3/0644; G06F 3/0689

(57) ABSTRACT

A data organization method and apparatus for a redundant array of independent disks, a server, and a medium. The method includes: acquiring all strips of a redundant array of independent disks, and setting a to-be-formatted mark in a bitmap corresponding to each strip; formatting the redundant array of independent disks in units of strips, and allowing a data write operation; in response to detecting that a strip provided with a to-be-formatted mark has been formatted, then modifying in a bitmap the to-be-formatted mark of the formatted strip to a formatting-completed mark; and sequentially performing data recovery on strips provided with formatting-completed marks.

### CROSS-REFERENCE TO RELATED APPLICATION

This application claims priority to Chinese Patent Application No. 202211507733.5, filed on Nov. 29, 2022 in China National Intellectual Property Administration and entitled “Data Organization Method and Apparatus for Redundant Array of Independent Disks, Server, and Medium”, which is hereby incorporated by reference in its entirety.

### FIELD

The present application relates to a data organization method and apparatus for a redundant array of independent disks (RAID), a computer device, a server, and a storage medium.

### BACKGROUND

A redundant array of independent disks (RAID), also known as a disk array, is a large disk system formed by multiple independent hard disks offering high storage capability and reliability compared to an individual disk. In this context, metadata refers to intermediate data (distinct from user data) generated during RAID operation and is stored in a memory with a power-failure protection function or stored in a non-transitory memory.

In related art, RAID reconstruction relies on metadata to describe a state of a strip, so as to determine whether the strip is reconstructed or unreconstructed. In this way, RAID reconstruction might be performed online and a record ensures that the reconstruction of the strip is only performed once, thereby significantly enhancing the efficiency of reconstruction and overall performance of a RAID system compared to a method of reconstructing strips from beginning to end. However, a major drawback of this method is that the reconstruction requires a large number of metadata to perform the above operation, but metadata that is stored in the memory with the power-failure protection function or the non-transitory memory, dramatically restricts the scale of support and increases costs. RAID formatting also adopts the abovementioned method. Compared to the metadata for reconstruction, the metadata for RAID formatting is smaller in unit size but bigger in volume.

Most reconstruction techniques are implemented by using a bitmap (a continuous memory). In such implementations, each bit in the bitmap represents a chunk or strip on a failed disk. 1 on a bit suggests that an area has not yet been reconstructed, while 0 on a bit suggests that an area has been reconstructed. When all valid bits in the bitmap are marked with zero, it indicates that the entire failed disk has been reconstructed. The bitmap is stored in a metadata area of the disk as metadata. However, the inventors have recognized that this reconstruction method applies reconstruction to entire data in the disk from the beginning to the end, which is time-consuming and inefficient. Moreover, read/write operations are generally not performed during reconstruction, and are performed only after reconstruction is completed in order to prevent data loss. This means that RAID reconstruction and data read/write operation both take up a separate memory space.

### SUMMARY

According to embodiments disclosed in the present application, a data organization method for a redundant array of independent disks (RAID) is provided. The method includes:
acquiring all strips of a RAID and setting a to-be-formatted mark in a bitmap corresponding to each strip;
formatting the RAID in units of strips, and allowing a data write operation;
in response to detecting that a strip provided with a to-be-formatted mark has been formatted, modifying in the bitmap the mark of the formatted strip into a formatting-completed mark; and
sequentially performing data recovery on strips provided with formatting-completed marks.

According to embodiments disclosed in the present application, a data organization apparatus for a redundant array of independent disks is provided. The apparatus includes:
an identification module, configured to acquire all strips of a RAID and set a to-be-formatted mark in a bitmap corresponding to each strip;
a data organization module, configured to format the RAID in units of strips, and allow a data write operation;
a bitmap module, configured to, in response to detecting that a strip provided with a to-be-formatted mark has been formatted, modify in a bitmap the mark of the formatted strip into a formatting-completed mark; and
a data recovery module, configured to sequentially perform data recovery on strips provided with formatting-completed marks.

According to embodiments disclosed in the present application, a server is provided. The server includes a RAID, which is configured to implement the data organization method for a redundant array of independent disks according to any one of the above embodiments.

According to embodiments of the present application, a non-transitory computer-readable storage medium is provided, and stores computer-readable instructions. The computer-readable instructions, when executed by a processor, implement the data organization method for a redundant array of independent disks according to any one of the above embodiments.

According to embodiments of the present application, a computer device is provided, including a memory, a processor, and computer-readable instructions stored in the memory and capable of running on the processor. The processor executes the computer-readable instructions to implement the data organization method for a redundant array of independent disks according to any one of the above embodiments.

### BRIEF DESCRIPTION OF THE DRAWINGS

In order to describe technical solutions of embodiments of the present application more clearly, drawings required to be used in the embodiments of the present application will be simply introduced below. It is apparent that the drawings described below are only some embodiments of the present application. Other drawings may further be obtained by those of ordinary skill in the art according to these drawings without creative work.

FIG. 1 is a schematic diagram of an application environment of a data organization method for a redundant array of independent disks according to one or more embodiments;

FIG. 2 is a flowchart illustrating a data organization method for a redundant array of independent disks according to one or more embodiments;

FIG. 3 is a flowchart illustrating a step of formatting a RAID in units of strips according to one or more embodiments;

FIG. 4 is a flowchart illustrating a step of sequentially performing data recovery on strips provided with formatting-completed marks according to one or more embodiments;

FIG. 5 is a flowchart illustrating a step of performing data recovery on a RAID in units of strips in response to detecting that identified mark information is a formatting-completed mark according to one or more embodiments;

FIG. 6 is a flowchart illustrating a step of performing data recovery by using a reconstruction algorithm and deleting a failure mark of a strip in response to detecting that identified mark information includes both a formatting-completed mark and a failure mark according to one or more embodiments;

FIG. 7 is a flowchart illustrating a step of performing a data write operation according to one or more embodiments;

FIG. 8 is a flowchart illustrating a step of performing data recovery in response to detecting that identified mark information includes both a formatting-completed mark and a failure mark according to one or more embodiments;

FIG. 9 is a flowchart illustrating a step of sequentially performing data recovery on strips provided with to-be-recovered marks according to one or more embodiments;

FIG. 10 is a structural block diagram of a data organization apparatus for a redundant array of independent disks according to one or more embodiments;

FIG. 11 is a schematic diagram of an internal structure of a computer device according to one or more embodiments; and

FIG. 12 is a schematic structural diagram of a non-transitory computer-readable storage medium according to one or more embodiments.

### DETAILED DESCRIPTION

For making purposes, technical solutions, and advantages of the present application clearer, the present application will further be described below with reference to the accompanying drawings and the embodiments in detail. It should be understood that the specific embodiments described herein are merely illustrative of the present application and are not intended to limit the present application.

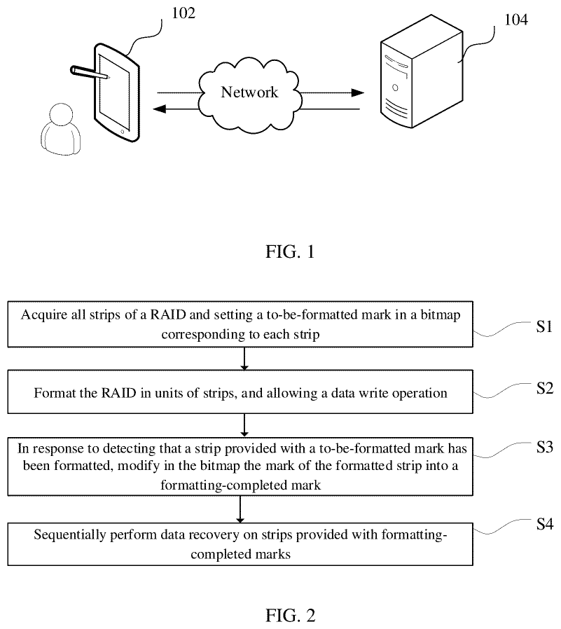

A data organization method for a redundant array of independent disks (RAID) provided in the present application might be applied to an application environment as shown in FIG. 1. A terminal 102 communicates with a server 104 over a network. The terminal 102 may include, but is not limited to, various types of personal computers, laptop computers, smartphones, tablet computers, and portable wearable devices. The server 104 may be a standalone server or a server cluster composed of a plurality of servers.

In one or more embodiments, as shown in FIG. 2, a data organization method for a RAID is provided. An example in which the data organization method is applied to the server 104 in FIG. 1 is taken for description, and the data organization method includes the following steps:
Step S1: acquiring all strips of a RAID and setting a to-be-formatted mark in a bitmap corresponding to each strip;
Step S2: formatting the RAID in units of strips, and allowing a data write operation;
Step S3: in response to detecting that a strip provided with a to-be-formatted mark has been formatted, modifying in the bitmap the mark of the formatted strip into a formatting-completed mark; and
Step S4: sequentially performing data recovery on strips provided with formatting-completed marks.

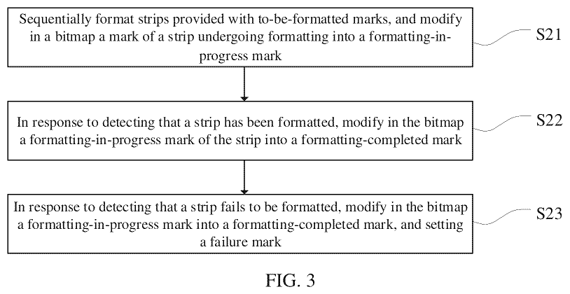

As shown in FIG. 3, in the present embodiment, the step of formatting the RAID in units of strips includes:
Step S21: sequentially formatting strips provided with to-be-formatted marks, and modifying in a bitmap a mark of a strip undergoing formatting into a formatting-in-progress mark; and
Step S22: in response to detecting that a strip has been formatted, modifying in the bitmap a formatting-in-progress mark of the strip into a formatting-completed mark.

As shown in FIG. 3, in the present embodiment, the step of sequentially formatting strips provided with to-be-formatted marks further includes:
Step S23: in response to detecting that a strip fails to be formatted, modifying in the bitmap a formatting-in-progress mark into a formatting-completed mark, and setting a failure mark.

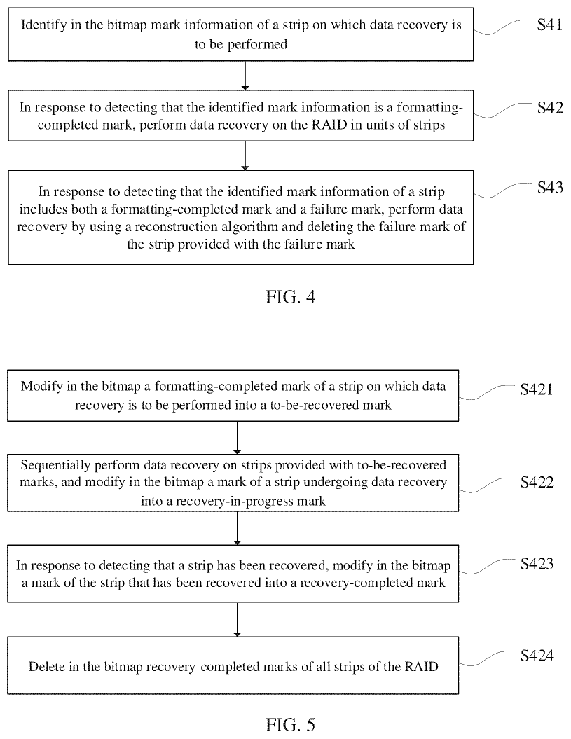

As shown in FIG. 4, in the present embodiment, the step of sequentially performing data recovery on strips provided with formatting-completed marks further includes:
Step S41: identifying in the bitmap mark information of a strip on which data recovery is to be performed;
Step S42: in response to detecting that the identified mark information is a formatting-completed mark, performing data recovery on the RAID in units of strips; and
Step S43: in response to detecting that the identified mark information of a strip includes both a formatting-completed mark and a failure mark, performing data recovery by using a reconstruction algorithm and deleting the failure mark of the strip provided with the failure mark.

As shown in FIG. 5, in the present embodiment, the step of in response to detecting that the identified mark information is a formatting-completed mark, performing data recovery on the RAID in units of strips includes:
Step S421: modifying in the bitmap a formatting-completed mark of a strip on which data recovery is to be performed into a to-be-recovered mark;
Step S422: sequentially performing data recovery on strips provided with to-be-recovered marks, and modifying in the bitmap a mark of a strip undergoing data recovery into a recovery-in-progress mark; and
Step S423: in response to detecting that a strip has been recovered, modifying in the bitmap a mark of the strip that has been recovered into a recovery-completed mark.

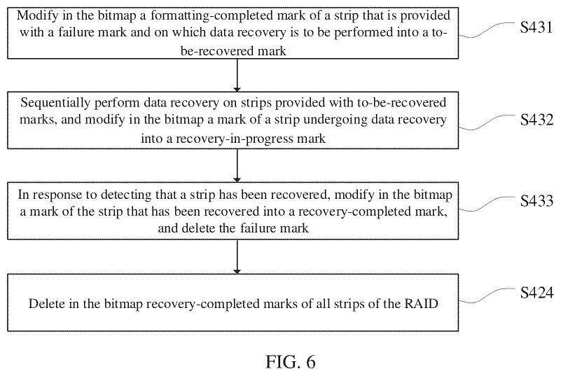

As shown in FIG. 6, in the present embodiment, the step of in response to detecting that the identified mark information of a strip includes both a formatting-completed mark and a failure mark, performing data recovery by using a reconstruction algorithm and deleting the failure mark of the strip provided with the failure mark includes:
Step S431: modifying in the bitmap a formatting-completed mark of a strip that is provided with a failure mark and on which data recovery is to be performed into a to-be-recovered mark;
Step S432: sequentially performing data recovery on strips provided with to-be-recovered marks, and modifying in the bitmap a mark of a strip undergoing data recovery into a recovery-in-progress mark; and
Step S433: in response to detecting that a strip has been recovered, modifying in the bitmap a mark of the strip that has been recovered into a recovery-completed mark, and deleting the failure mark.

In the present embodiment, the data write operation includes:
identifying in the bitmap mark information for a strip to which data is to be written;
in response to detecting that the identified mark information is a to-be-formatted mark, writing data directly;
in response to detecting that the identified mark information is a formatting-completed mark, writing data directly;
in response to detecting that the identified mark information is a formatting-in-progress mark, writing data after the mark information is modified into a formatting-completed mark; and
in response to detecting that the identified mark information is a to-be-recovered mark or a recovery-in-progress mark, writing data after the mark information is modified into a recovery-completed mark.

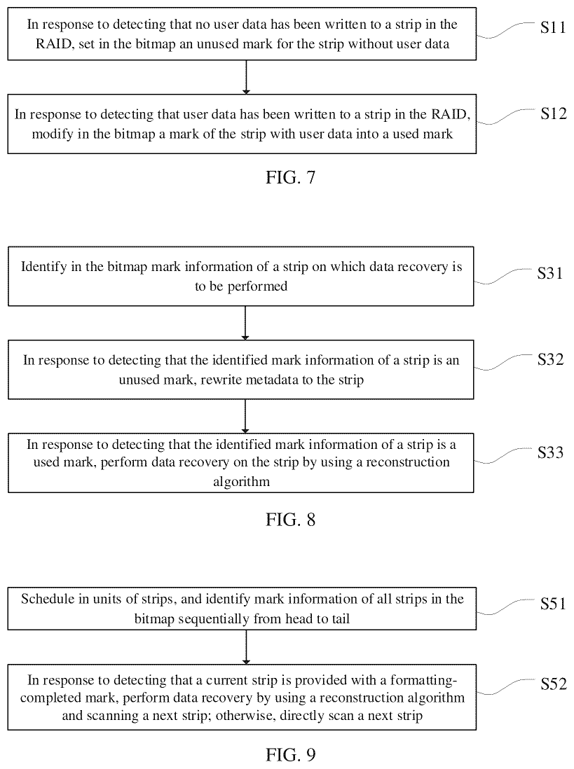

As shown in FIG. 7, in the present embodiment, the data write operation includes:
Step S11: in response to detecting that no user data has been written to a strip in the RAID, setting in the bitmap an unused mark for the strip without user data; and
Step S12: in response to detecting that user data has been written to a strip in the RAID, modifying in the bitmap a mark of the strip with user data into a used mark.

In the present embodiment, in response to detecting that only metadata is present in a strip of the RAID, that no user data has been written to the strip is determined; and
in response to detecting that user data is present in a strip of the RAID, that user data has been written to the strip is determined.

As shown in FIG. 8, in the present embodiment, the step of sequentially performing data recovery on strips provided with formatting-completed marks, after the in response to detecting that the identified mark information includes both a formatting-completed mark and a failure mark, further includes:
Step S31: identifying in the bitmap mark information of a strip on which data recovery is to be performed;
Step S32: in response to detecting that the identified mark information of a strip is an unused mark, rewriting metadata to the strip; and
Step S33: in response to detecting that the identified mark information of a strip is a used mark, performing data recovery on the strip by using a reconstruction algorithm.

In the present embodiment, a data read operation is allowed during formatting of the RAID in units of strips.

In the present embodiment, the data read operation includes:
acquiring in the bitmap a storage location number of data to be read, and acquiring a corresponding strip based on the storage location number;
identifying mark information of the acquired strip in the bitmap;
in response to detecting that the identified mark information includes a used mark and a formatting-completed mark, directly reading the data;
in response to detecting that the identified mark information includes a used mark and a to-be-formatted mark, directly reading the data;
in response to detecting that the identified mark information includes a used mark and a formatting-in-progress mark, reading data after the mark information is modified into a formatting-completed mark;
in response to detecting that the identified mark information includes a used mark and a to-be-recovered mark, reading data after the mark information is modified into a recovery-completed mark; and
in response to detecting that the identified mark information includes a used mark and a recovery-in-progress mark, reading data after the mark information is modified into a recovery-completed mark.

As shown in FIG. 5 and FIG. 6, in the present embodiment, after the step of sequentially performing data recovery on strips provided with formatting-completed marks, the method further includes:
Step S424: deleting in the bitmap recovery-completed marks of all strips of the RAID

As shown in FIG. 9, in the present embodiment, the step of sequentially performing data recovery on strips provided with to-be-recovered marks includes:
Step S51: scheduling in units of strips, and identifying mark information of all strips in the bitmap sequentially from head to tail; and
Step S52: in response to detecting that a current strip is provided with a formatting-completed mark, performing data recovery by using a reconstruction algorithm and scanning a next strip; otherwise, directly scanning a next strip.

In the above data organization method for a RAID, read and write operations are allowed during formatting in progress, and priority is given to formatting strips involved in read/write operations. Metadata is used to record a formatting state, thereby avoiding repeated formatting. In this way, online reconstruction might be achieved, requirements of the server for online read/write operations might be met, each strip is reconstructed only once to the extent possible, and persistent memory footprint of the RAID is reduced.

It should be understood that although the steps in the flowcharts of FIG. 2 to FIG. 9 are illustrated sequentially according to the direction of arrows, the steps are not necessarily executed in that indicated sequence unless explicitly stated otherwise. Unless otherwise explicitly stated herein, there is no strict limitation on the execution sequence of these steps, and these steps may be executed in an alternative sequence. Moreover, at least some of the steps in FIG. 2 to FIG. 9 may include a plurality of sub-steps or phases, which may not be completed at the same time. These sub-steps or phases may be executed at different times, and may not be necessarily executed sequentially; rather, they may be executed alternately or in an interleaved manner with at least a portion of other steps or other sub-steps or phases of other steps.

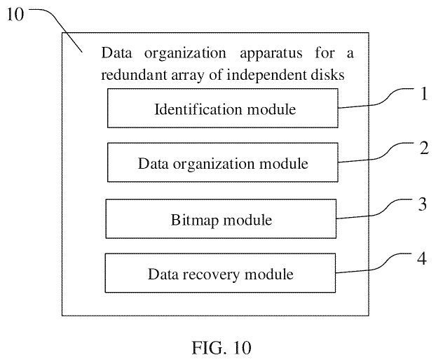

In one or more embodiments, as shown in FIG. 10, a data organization apparatus 10 for a RAID is provided. The apparatus includes: an identification module 1, a data organization module 2, a bitmap module 3, and a data recovery module 4.

The identification module 1 is configured to acquire all strips of a RAID and set a to-be-formatted mark in a bitmap corresponding to each strip.

The data organization module 2 is configured to format the RAID in units of strips, and allow a data write operation.

The bitmap module 3 is configured to, in response to detecting that a strip provided with a to-be-formatted mark has been formatted, modify in a bitmap the mark of the formatted strip into a formatting-completed mark.

The data recovery module 4 is configured to sequentially perform data recovery on strips provided with formatting-completed marks.

In the present embodiment, the step of formatting the RAID in units of strips includes:
sequentially formatting strips provided with to-be-formatted marks, and modifying in the bitmap a mark of a strip undergoing formatting into a formatting-in-progress mark; and
in response to detecting that a strip has been formatted, modifying in the bitmap a formatting-in-progress mark into a formatting-completed mark.

In the present embodiment, the data organization module 2 includes a controller and a drive. The controller configures the drive as a member and initiates a background formatting task for the RAID. The identification module 1 is configured to determine that a corresponding strip is a failed strip when the strip fails to be formatted. The bitmap module 3 sets in the bitmap a failure mark for the failed strip.

In the present embodiment, the step of sequentially performing data recovery on strips provided with formatting-completed marks further includes:
identifying in the bitmap mark information of a strip on which data recovery is to be performed;
in response to detecting that the identified mark information is a formatting-completed mark, performing data recovery on the RAID in units of strips; and
in response to detecting that the identified mark information includes both a formatting-completed mark and a failure mark, performing data recovery by using a reconstruction algorithm and deleting the failure mark of the strip provided with the failure mark.

In the present embodiment, the step of in response to detecting that identified mark information is a formatting-completed mark, performing data recovery on the RAID in units of strips includes:
modifying in the bitmap a formatting-completed mark of a strip on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark.

In the present embodiment, the step of in response to detecting that identified mark information includes both a formatting-completed mark and a failure mark, performing data recovery by using a reconstruction algorithm and deleting the failure mark of the strip includes:
modifying in the bitmap a formatting-completed mark of a strip that is provided with a failure mark and on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark, and deleting the failure mark.

In the present embodiment, the data write operation includes:
identifying in the bitmap mark information for a strip to which data is to be written;
in response to detecting that the identified mark information is a to-be-formatted mark, writing data directly;
in response to detecting that the identified mark information is a formatting-completed mark, writing data directly;
in response to detecting that the identified mark information is a formatting-in-progress mark, writing data after the mark information is modified into a formatting-completed mark; and
in response to detecting that the identified mark information is a to-be-recovered mark or a recovery-in-progress mark, writing data after the mark information is modified into a recovery-completed mark.

In the present embodiment, the data write operation includes:
in response to detecting that no user data has been written to a strip in the RAID, setting in the bitmap an unused mark for the strip without user data; and
in response to detecting that user data has been written to a strip in the RAID, modifying in the bitmap a mark of the strip with user data into a used mark.

In the present embodiment, in response to detecting that only metadata is present in a strip of the RAID, that no user data has been written to the strip is determined; and in response to detecting that user data is present in a strip of the RAID, that user data has been written to the strip is determined.

In the present embodiment, the step of sequentially performing data recovery on strips provided with formatting-completed marks, after the in response to detecting that the identified mark information includes both a formatting-completed mark and a failure mark, further includes:
identifying in the bitmap mark information of a strip on which data recovery is to be performed;
in response to detecting that the identified mark information of a strip is an unused mark, rewriting metadata to the strip; and
in response to detecting that the identified mark information of a strip is a used mark, performing data recovery on the strip by using a reconstruction algorithm.

In the present embodiment, the data organization module 2 is configured to format the RAID in units of strips and allow a data read operation.

In the present embodiment, the data read operation includes:
acquiring in the bitmap a storage location number of data to be read, and acquiring a corresponding strip based on the storage location number;
identifying mark information of the acquired strip in the bitmap;
in response to detecting that the identified mark information includes a used mark and a formatting-completed mark, directly reading the data;
in response to detecting that the identified mark information includes a used mark and a to-be-formatted mark, directly reading the data;
in response to detecting that the identified mark information includes a used mark and a formatting-in-progress mark, reading data after the mark information is modified into a formatting-completed mark;
in response to detecting that the identified mark information includes a used mark and a to-be-recovered mark, reading data after the mark information is modified into a recovery-completed mark; and
in response to detecting that the identified mark information includes a used mark and a recovery-in-progress mark, reading data after the mark information is modified into a recovery-completed mark.

In the present embodiment, after the step of sequentially performing data recovery on strips provided with formatting-completed marks, the method further includes:
deleting in the bitmap recovery-completed marks of all strips of the RAID.

In the present embodiment, the step of sequentially performing data recovery on strips provided with to-be-recovered marks includes:
scheduling in units of strips, and identifying mark information of all strips in the bitmap sequentially from head to tail; and
in response to detecting that a current strip is provided with a formatting-completed mark, performing data recovery by using a reconstruction algorithm and scanning a next strip; otherwise, directly scanning a next strip.

In the above data organization apparatus for a RAID, read and write operations are allowed during formatting in progress, and priority is given to formatting strips involved in read/write operations. Metadata is used to record a formatting state, thereby avoiding repeated formatting. In this way, online reconstruction might be achieved, requirements of the server for online read/write operations might be met, each strip is reconstructed only once to the extent possible, and persistent memory footprint of the RAID is reduced.

The specific limitations of the data organization apparatus for a RAID may be referred to in the above description of the data organization method for a RAID, and will not be repeated herein. The modules in the above data organization apparatus for a RAID may be implemented wholly or partially by software, hardware, or a combination thereof. The modules may be embedded in or independent of a processor of a computer device in a hardware form, or stored in a memory of the computer device in a software form for the processor to invoke and execute the corresponding operations of each module.

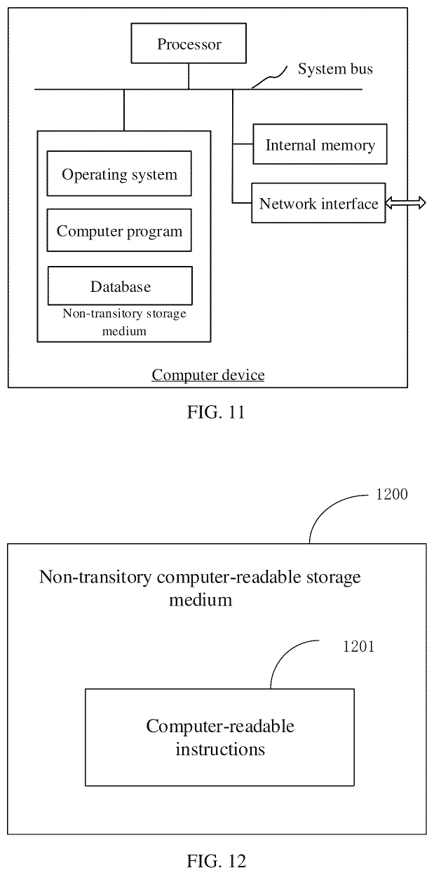

In one or more embodiment, a computer device is provided. The computer device may be a server. An internal structure of the computer device may be as illustrated in FIG. 11. The computer device includes a processor, a memory, a network interface, and a database which are connected via a system bus. The processor of the computer device is configured to provide computing and control capabilities. The memory includes a non-transitory storage medium and an internal memory. The non-transitory storage medium stores an operating system, computer-readable instructions, and the database. The internal memory provides a runtime environment for the operating system and the computer-readable instructions stored in the non-transitory storage medium. The database of the computer device is configured to store data organization information for the RAID. The network interface is configured to communicate with external terminals over a network. The computer-readable instructions, when executed by the processor, implement a data organization method for a RAID.

Those skilled in the art may understand that a structure shown in FIG. 11 is only a block diagram of a partial structure related to the solutions of the present application and not intended to limit the computer device to which the solutions of the present application are applied. The computer device may in some embodiments include components more or fewer than those shown in the figure, or some components are combined or different component arrangements are adopted.

In one or more embodiment, a computer device is provided, including a memory, a processor, and computer-readable instructions stored in the memory and capable of running on the processor, the processor executing the computer-readable instructions to implement the steps of the data organization method according to any one or more embodiments.

The specific limitations to the steps implemented when the processor executes the computer-readable instructions might be referred to in the foregoing description of the data organization method for a RAID and will not be repeated herein.

In one or more embodiments, a non-transitory computer-readable storage medium is provided. FIG. 12 is a schematic structural diagram of a non-transitory computer-readable storage medium according to one or more embodiments. Computer-readable instructions 1201 are stored on a non-transitory computer-readable storage medium 1200. When executed by a processor, the computer-readable instructions 1201 implement the steps of the data organization method according to any one or more embodiments.

Those of ordinary skill in the art should understand that all or part of the flows in the method of the abovementioned embodiments may be completed through related hardware instructed by computer-readable instructions, the computer-readable instructions may be stored in a non-transitory computer-readable storage medium, and when the computer-readable instructions are executed, the flows of each method embodiment may be included. Any reference made to a memory, a storage, a database or another medium used in the embodiments of the present application may include a non-transitory memory and/or a volatile memory. The non-transitory memory may include a read-only memory (ROM), a programmable ROM (PROM), an electrically programmable ROM (EPROM), an electrically erasable programmable ROM (EEPROM), or a flash memory. The non-transitory memory may include a random access memory (RAM) or an external high-speed cache memory. Illustratively rather than restrictively, the RAM may be obtained in various forms, for example, a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), a Rambus Direct RAM (RDRAM), a Direct RDRAM (DRDRAM) and a Rambus Dynamic RAM (RDRAM).

Each technical feature of the above embodiments may be freely combined. For brief description, not all possible combinations of each technical feature in the abovementioned embodiments are described, but all the combinations of these technical features shall fall within the scope of the description without conflicts.

The abovementioned embodiments only describe some implementations of the present application and are in some embodiments described in detail and not thus understood as limits to the patent scope of the present application. It is to be pointed out that those of ordinary skill in the art may further make various modifications and improvements without departing from the concept of the present application, all of which shall fall within the protection scope of the present application. Therefore, a scope of patent protection of the present application should be subject to the appended claims.

1. A data organization method for a redundant array of independent disks (RAID), comprising:
acquiring all strips of the RAID and setting a to-be-formatted mark in a bitmap corresponding to each strip;
formatting the RAID in units of strips, sequentially formatting strips provided with to-be-formatted marks, modifying in the bitmap a mark of a strip undergoing formatting into a formatting-in-progress mark, and allowing a data write operation;
in response to detecting that a strip provided with a to-be-formatted mark has been formatted, modifying in the bitmap the mark of the formatted strip into a formatting-completed mark;
in response to detecting that a strip fails to be formatted, modifying in the bitmap a formatting-in-progress mark into a formatting-completed mark, and setting a failure mark; and
sequentially performing data recovery on strips provided with formatting-completed marks, wherein the sequentially performing data recovery on strips provided with formatting-completed marks comprises:
identifying in the bitmap mark information of a strip on which data recovery is to be performed;
in response to detecting that the identified mark information is a formatting-completed mark, performing data recovery on the RAID in units of strips; and
in response to detecting that the identified mark information comprises both a formatting-completed mark and a failure mark, performing data recovery by using a reconstruction algorithm and deleting the failure mark of the strip provided with the failure mark.

2.-4. (canceled)

5. The data organization method for a RAID according to claim 1, wherein the in response to detecting that the identified mark information is a formatting-completed mark, performing data recovery on the RAID in units of strips comprises:
modifying in the bitmap a formatting-completed mark of the strip on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark.

6. The data organization method for a RAID according to claim 1, wherein the in response to detecting that the identified mark information comprises both a formatting-completed mark and a failure mark, performing data recovery by using a reconstruction algorithm and deleting the failure mark of the strip provided with the failure mark comprises:
modifying in the bitmap a formatting-completed mark of a strip that is provided with a failure mark and on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark, and deleting the failure mark.

7. The data organization method for a RAID according to claim 5, wherein the data write operation comprises:
identifying in the bitmap mark information for a strip to which data is to be written;
in response to detecting that the identified mark information is a to-be-formatted mark, writing data directly;
in response to detecting that the identified mark information is a formatting-completed mark, writing data directly;
in response to detecting that the identified mark information is a formatting-in-progress mark, writing data after the mark information is modified into a formatting-completed mark; and
in response to detecting that the identified mark information is a to-be-recovered mark or a recovery-in-progress mark, writing data after the mark information is modified into a recovery-completed mark.

8. The data organization method for a RAID according to claim 7, wherein the data write operation comprises:
in response to detecting that no user data has been written to a strip in the RAID, setting in the bitmap an unused mark for the strip without user data; and
in response to detecting that user data has been written to a strip in the RAID, modifying in the bitmap a mark of the strip with user data into a used mark.

9. The data organization method for a RAID according to claim 8, further comprising in response to detecting that only metadata is present in a strip of the RAID, determining that no user data has been written to the strip; and in response to detecting that user data is present in a strip of the RAID, determining that user data has been written to the strip.

10. The data organization method for a RAID according to claim 9, wherein after the in response to detecting that the identified mark information comprises both a formatting-completed mark and a failure mark, the method further comprises:
identifying in the bitmap mark information of a second strip on which data recovery is to be performed;
in response to detecting that the identified mark information of the second strip is an unused mark, rewriting metadata to the second strip; and
in response to detecting that the identified mark information of the second strip is a used mark, performing data recovery on the second strip by using a reconstruction algorithm.

11. The data organization method for a RAID according to claim 10, wherein during formatting of the RAID in units of strips, a data read operation is allowed.

12. The data organization method for a RAID according to claim 11, wherein the data read operation comprises:
acquiring in the bitmap a storage location number of data to be read, and acquiring a corresponding strip based on the storage location number;
identifying mark information of the acquired strip in the bitmap;
in response to detecting that the identified mark information comprises a used mark and a formatting-completed mark, directly reading the data;
in response to detecting that the identified mark information comprises a used mark and a to-be-formatted mark, directly reading the data;
in response to detecting that the identified mark information comprises a used mark and a formatting-in-progress mark, reading data after the mark information is modified into a formatting-completed mark;
in response to detecting that the identified mark information comprises a used mark and a to-be-recovered mark, reading data after the mark information is modified into a recovery-completed mark; and
in response to detecting that the identified mark information comprises a used mark and a recovery-in-progress mark, reading data after the mark information is modified into a recovery-completed mark.

13. The data organization method for a RAID according to claim 5-er 6, wherein after the sequentially performing data recovery on strips provided with formatting-completed marks, the method further comprises:
deleting in the bitmap recovery-completed marks of the strips of the RAID.

14. The data organization method for a RAID according to claim 5, wherein the sequentially performing data recovery on strips provided with to-be-recovered marks comprises:
scheduling in units of strips, and identifying mark information of the strips in the bitmap sequentially from head to tail; and
in response to detecting that a current strip is provided with a formatting-completed mark, performing data recovery by using a reconstruction algorithm and scanning a next strip.

15.-16. (canceled)

17. The data organization method for a RAID according to claim 1, wherein before the formatting the RAID in units of strips, the method further comprises:
initiating a background formatting task for the RAID by configuring a drive as an array member by means of a controller.

18. A server, comprising a redundant array of independent disks (RAID), the RAID, when used, implementing steps of a data organization method, comprising:
acquiring all strips of the RAID and setting a to-be-formatted mark in a bitmap corresponding to each strip;
formatting the RAID in units of strips, sequentially formatting strips provided with to-be-formatted marks, modifying in the bitmap a mark of a strip undergoing formatting into a formatting-in-progress mark, and allowing a data write operation;
in response to detecting that a strip provided with a to-be-formatted mark has been formatted, modifying in the bitmap the mark of the formatted strip into a formatting-completed mark;
in response to detecting that a strip fails to be formatted, modifying in the bitmap a formatting-in-progress mark into a formatting-completed mark, and setting a failure mark; and
sequentially performing data recovery on strips provided with formatting-completed marks, wherein the sequentially performing data recovery on strips provided with formatting-completed marks comprises:
identifying in the bitmap mark information of a strip on which data recovery is to be performed;
in response to detecting that the identified mark information is a formatting-completed mark, performing data recovery on the RAID in units of strips; and
in response to detecting that the identified mark information comprises both a formatting-completed mark and a failure mark, performing data recovery by using a reconstruction algorithm and deleting the failure mark of the strip provided with the failure mark.

19. A computer device, comprising a memory, a processor, and computer-readable instructions stored in the memory and capable of running on the processor, wherein the processor executes the computer-readable instructions to implement steps of an data organization method, comprising:
acquiring all strips of a redundant array of independent disks (RAID) and setting a to-be-formatted mark in a bitmap corresponding to each strip;
formatting the RAID in units of strips, sequentially formatting strips provided with to-be-formatted marks, modifying in the bitmap a mark of a strip undergoing formatting into a formatting-in-progress mark, and allowing a data write operation;
in response to detecting that a strip provided with a to-be-formatted mark has been formatted, modifying in the bitmap the mark of the formatted strip into a formatting-completed mark;
in response to detecting that a strip fails to be formatted, modifying in the bitmap a formatting-in-progress mark into a formatting-completed mark, and setting a failure mark; and
sequentially performing data recovery on strips provided with formatting-completed marks, wherein the sequentially performing data recovery on strips provided with formatting-completed marks comprises:
identifying in the bitmap mark information of a strip on which data recovery is to be performed;
in response to detecting that the identified mark information is a formatting-completed mark, performing data recovery on the RAID in units of strips; and
in response to detecting that the identified mark information comprises both a formatting-completed mark and a failure mark, performing data recovery by using a reconstruction algorithm and deleting the failure mark of the strip provided with the failure mark.

20. A computer-readable storage medium, having computer-readable instructions stored therein, wherein the computer-readable instructions, when executed by a processor, implement steps of the data organization method according to claim 1.

21. The data organization method for a RAID according to claim 1, wherein the reconstruction algorithm is implemented in an online form.

22. The data organization method for a RAID according to claim 1, wherein the reconstruction algorithm is performed once for each strip of the strips.

23. The data organization method for a RAID according to claim 14, wherein the sequentially performing data recovery on strips provided with to-be-recovered marks comprises:
in response to not detecting that a current strip is provided with a formatting-completed mark, directly scanning a next strip of the strips.

24. The server according to claim 18, wherein the RAID is further configured to implement steps of:
modifying in the bitmap a formatting-completed mark of the strip on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark.

25. The server according to claim 18, wherein the RAID is further configured to implement steps of:
modifying in the bitmap a formatting-completed mark of a strip that is provided with a failure mark and on which data recovery is to be performed into a to-be-recovered mark;
sequentially performing data recovery on strips provided with to-be-recovered marks, and modifying in the bitmap a mark of a strip undergoing data recovery into a recovery-in-progress mark; and
in response to detecting that a strip has been recovered, modifying in the bitmap a mark of the strip that has been recovered into a recovery-completed mark, and deleting the failure mark.
